(19) United States
(12) Patent Application Publication
(10) Pub. No.: US 2025/0254763 A1
(43) Pub. Date: Aug. 7, 2025

(54) WINDOW DEFROSTER FOR SMALL STRUCTURES

(71) Applicant: David Hale, Somerset, WI (US)

(72) Inventor: David Hale, Somerset, WI (US)

(21) Appl. No.: 19/038,570

(22) Filed: Jan. 27, 2025

Related U.S. Application Data
(63) Continuation-in-part of application No. 18/424,541, filed on Jan. 26, 2024.

(51) Int. Cl. H05B 3/84

(52) U.S. Cl. CPC H05B 3/84

(57) ABSTRACT

A window defroster system for a heated hunting blind or similar small structure in cold weather conditions. The system includes one or more repositionable heater assemblies powered by a portable power supply such as a battery, battery pack or generator, and including a backer bar for each heater assembly. The backer bars have magnets positioned so as to correspond to magnets in the heater assemblies, enabling the heater assemblies to be attached to the windows.

### RELATED APPLICATIONS

The present application is a continuation-in-part of U.S. application Ser. No. 18/424,541, entitled WINDOW DEFROSTER FOR SMALL STRUCTURES, filed Jan. 26, 2024, said application being hereby fully incorporated herein in its entirety by reference.

### TECHNICAL FIELD

The present invention relates to window defrosters. More specifically, the present invention relates to window defrosters specifically configured for defrosting the windows of hunting blinds and other small, heated enclosures used in cold climates.

### BACKGROUND

Hunting blinds and other small structures typically include windows for viewing the ambient environment. Such structures are often heated using propane ceramic heaters. The use of such heaters causes water vapor to form within the structure. Moreover, moisture is also generated by the occupants. This water vapor condenses on windows of the structure causing frost to form on the windows or the windows to fog. This frost or fog makes it difficult to see through the windows, for example obscuring a hunter's ability to see game passing by a hunting blind.

Hunting blind manufacturers have typically offered a proposed solution to this problem, specifically wiping away the condensation. This, at best, is a temporary solution. Most typically, the windows quickly again fog or even frost over and the wiping action smears the windows decreasing visibility through the windows. Further, wiping the windows can display movement to passing game, and can cause undesirable scent on the exterior of the enclosure, particularly if defrosting fluids are used.

What is needed are systems and methods whereby windows of an enclosure can be kept free from fogging or frost without requiring the occupants of the enclosure to use fluids or display movement.

### SUMMARY

Embodiment of the present invention address the problems described above by providing window defrost systems for use in hunting blinds and other small enclosures with windows susceptible to fogging and frosting over. As used herein, “defroster” is used with reference to any such system used for defrosting or defogging a window.

One embodiment of the invention comprises a metal bar of a predetermined width (e.g., ¼ inch) and a predetermined length (e.g., 12 inches). The bar is adapted to be temporarily attached to the window using a fastener comprising magnets. Use of the magnets allows the bar to be quickly and easily repositioned for optimal performance. Other fasteners providing these same advantages may also be used without deviating from the invention. The metal bar is connected to a portable electrical power source (e.g., a battery or a portable generator). Application of electricity to, and the resistance of the metal of the bar, causes the bar to heat and the heat from the bar to radiate thereby defogging and defrosting the window to which the bar is attached.

Another embodiment of the invention comprises an assembly including a heating element, such as a polyimide thermal heat strip of a predetermined width and length (e.g., 5 millimeters by 185 millimeters), attached to and centered along the length of a heat sink of a predetermined width and length (e.g., ¼ inch by 12 inches). The fasteners of this embodiment comprise a separate N52 magnet is press fit into each end of the heat sink. Two additional magnets on the opposite side of a window are used to attach this assembly to the window. Other types of magnets, and other types of fasteners, such as spring clips and binder clips, may be used without deviating from the invention. An electrical power source such as a battery or portable generator is coupled to the heat strip to cause the heat strip to generate heat. This heat is transferred to the heat sink and radiates from the assembly across the window to which the assembly is attached and serves to defog/defrost the window. Again, the use of magnets to hold the assembly in place allows the assembly to be easily repositioned to maximize performance.

In an embodiment, a window defroster system includes a heater assembly configured to operate within an operating temperature range of 80 degrees Fahrenheit to 110 degrees Fahrenheit, and be placed in face-to-face registration with a first side of a window, the heater assembly having an elongate housing with a first pair of magnets, the first pair of magnets being spaced-apart by a first distance, a backer bar assembly configured to be placed in face-to-face registration with a second, opposing, side of the window, the backer bar assembly having an elongate housing with a second pair of magnets, the second pair of magnets being spaced-apart such that each magnet of the second pair is registerable with a separate one of the magnets of the first pair of magnets, and a portable power source electrically coupled to deliver power to the heater assembly The heater assembly can include a thermostat operably coupled to maintain a temperature within the operating temperature range.

In an embodiment, the heater assembly can include a switch electrically coupled to connect and disconnect a flow of power between the portable power source and the heater assembly. The heater assembly can include a heater bar, and the heater bar can be a heating element and a heat sink, or the heating element may be made from a material that is resistive, has a melting point above the highest temperature of the predetermined operating temperature range, and has a temperature coefficient of resistivity sufficiently low to enable the heater to generate sufficient heat to defrost and defog the window. The heating element may be a polyimide heater having an etched foil encapsulated between two layers of polyimide film. The heat sink material may be selected from a group consisting of aluminum, black anodized aluminum, nickel-chromium alloy, iron-chromium-aluminum alloy, and copper-nickel alloy. The first pair of magnets and the second pair of magnets may be made from a material selected from the group consisting of ferrite, cobalt, and neodymium.

In embodiments, the window defroster system can include a second heater assembly and a second backer bar assembly.

In other embodiments, a window defroster system includes a pair of heater assemblies, one of the pair of heater assemblies adapted to be placed in face-to-face registration with a first side of a first window, the other one of the pair of heater assemblies adapted to be placed in face-to-face registration with a first side of a second window, each heater assembly having an elongate housing presenting a proximate end, a distal end, and having a pair of magnets disposed in the elongate housing, one of the pair of magnets being disposed proximate the proximal end, and the other one of the pair of magnets being disposed proximate the distal end, a pair of backer bar assemblies, each one of the pair of backer bar assemblies presenting a proximate end, a distal end, and having a pair of backer bar magnets disposed in the elongate housing, one of the pair of backer bar magnets being disposed proximate the proximal end, and the other one of the pair of backer bar magnets being disposed proximate the distal end, a spacing distance between the backer bar magnets of each backer bar assembly being selected to match a spacing distance between the pair of magnets of a corresponding one of the pair of heater assemblies, a portable power source, and a wiring harness electrically coupling the portable power source with the pair of heater assemblies.

The portable power source may be a rechargeable lithium-ion battery and each heater assembly may include a thermostat. The wiring harness can include a switch electrically coupled to connect and disconnect a flow of power between the portable power source and the heater assemblies.

In embodiments, each heater assembly includes a heater bar, which may be a heating element and a heat sink. The heating element can be polyimide heater having an etched foil encapsulated between two layers of polyimide film.

In further embodiments the heating element is made from a material that is resistive, has a melting point above the highest temperature of a predetermined operating temperature range, and has a temperature coefficient of resistivity sufficiently low to enable the heater to generate sufficient heat to defrost and defog the window.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The subject matter hereof may be more completely understood in consideration of the following detailed description of various embodiments in connection with the accompanying figures, in which:

FIG. 1 is a front view of a first embodiment of a window defroster/defogger made in accordance with the present invention;

FIG. 2 is a front view of a second embodiment of a window defroster/defogger made in accordance with the present invention;

FIG. 3 is a top view of the window defroster/defogger of FIG. 1 attached to a window of a hunting blind or the like;

FIG. 4 is a top view of the window defroster/defogger of FIG. 2 attached to a window of a hunting blind or the like;

FIG. 5 is a schematic diagram showing additional features that may be used to control the operation of the heating element of FIGS. 2 and 4;

FIG. 6 illustrates the use of clips to temporarily fasten a heater to a window;

FIG. 7 illustrates the use of clips, in combination with a strap, to temporarily fasten a heater to a window;

FIG. 8 is an isometric view of a window defroster system according to another embodiment of the invention;

FIG. 9 is an isometric view of the heater assembly of the system of FIG. 8, with the internal components of the heater assembly shown in phantom;

FIG. 10 is an electrical schematic of the system of FIG. 8;

FIG. 11 is a top isometric view of the backer bar of the system of FIG. 8;

FIG. 12 is a bottom exploded isometric view of the backer bar of the system of FIG. 8;

FIG. 13 is a perspective view of the system of FIG. 8 installed on a window;

FIG. 14 is a cross-sectional view taken at section 14-14 of FIG. 13;

FIG. 15 is an isometric view of a window defroster system including multiple heater assemblies; and

FIG. 16 is an electrical schematic of the system of FIG. 15.

While various embodiments are amenable to various modifications and alternative forms, specifics thereof have been shown by way of example in the drawings and will be described in detail. It should be understood, however, that the intention is not to limit the claimed inventions to the embodiments described. On the contrary, the intention is to cover all modifications, equivalents, and alternatives falling within the spirit and scope of the subject matter as defined by the claims.

### DETAILED DESCRIPTION OF THE DRAWINGS

This description is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

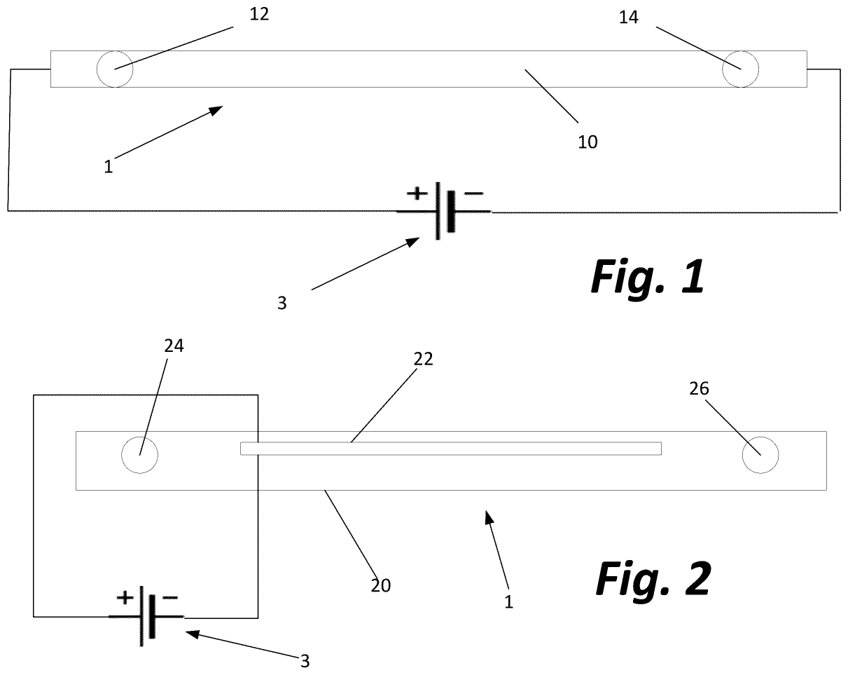

Two embodiments of a defroster 1 made in accordance with the present invention are shown in FIGS. 1 through 4 of the drawings. Each is configured to be positioned relative to window 2 and then attached to window 2 in a manner that permits easy repositioning of the defroster 1 relative to the boundaries of a surface of the window 2. Each is powered by a portable power source 3 such as a battery, a group of batteries or a portable generator.

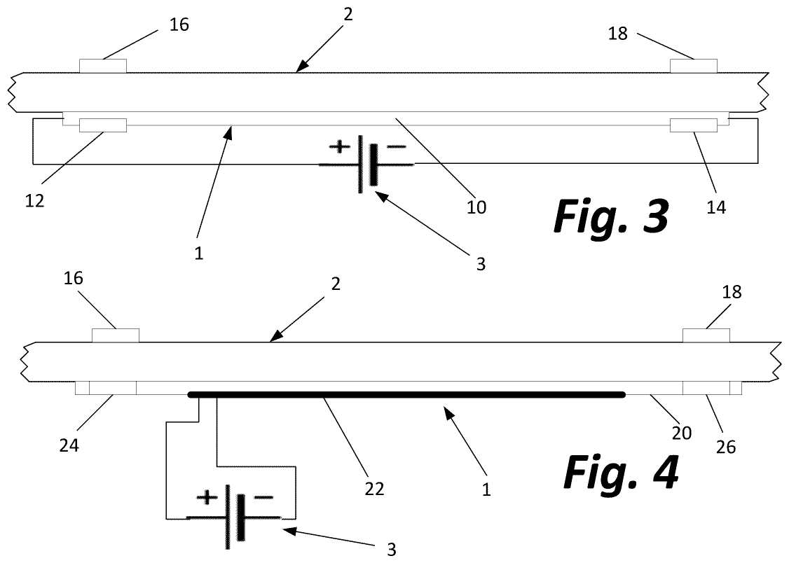

The embodiment shown in FIGS. 1 and 3 generally includes heater consisting of a metal bar 10. Metal bar 10 is attached to the power source 3 and produces heat according to the following equation E=I²Rt Joules where “I” is the current through the resistance in amps, “R” is the resistance of the metal bar and “T” is the time in seconds. The metal bar may be made from aluminum, black anodized aluminum or an alloy that is highly resistive, has a high melting point, is resistant to oxidation, has a high tensile strength, and a low temperature coefficient of resistivity. More specifically, the highly resistive metal bar 10 is made from a material that has a high enough melting point and a low enough coefficient of resistivity to permit the metal bar 10 to be operated within the predetermined operating temperature range of the heater. Nickel-chromium alloys, iron-chromium-aluminum alloys, and copper-nickel alloys, among other alloys, may be used.

While counter intuitive given that a higher temperature weakens a magnet's strength and magnetic field, magnets are used to attach metal bar 10 to window 2. Specifically, magnets 12 and 14 are coupled to metal bar 10 and the heater is placed in face-to face registration with one side of a window of an enclosure. Magnets 16 and 18 are position in face-to-face registration with a second side of the window adjacent to magnets 12 and 14 with opposite poles of each pair of magnets (i.e., 12 and 16, and 14 and 18) facing each other. The type of material from which a magnet is made determines how temperature affects the magnet. Ferrite magnets and magnets made of cobalt have a high resistance to demagnetization and are suitable for use. Neodymium magnets, for example, N52 neodymium magnets may also be used so long as the temperature of the metal bar does not exceed about 175 degrees Fahrenheit. Of course, the metal bar should be held well below that temperature, e.g., in a range of 80 degrees Fahrenheit to about 110 degrees Fahrenheit, even when connected to the power source to prevent injury to someone touching the metal bar 10. This temperature range is also adequate to effectively defog and defrost windows. The magnets may be epoxy coated so that they are not adversely affected by humidity.

The alternative embodiment of FIGS. 2 and 4 replaces the metal bar 10 with a different heater, specifically with an assembly comprising a heat sink 20 and a heating element 22. Heat sink 20 may be made of any material having a high thermal conductivity. Copper may be used, for example. However, aluminum may be more suitable due to its lower cost and relatively high thermal conductivity. The heat sink 20 may be flat at shown, or otherwise have a flat surface, so that it can sit in face-to-face registration with the window 2. The heat sink may also have fins or pins to increase the surface area for heat transfer. Of course, the surface area of the heat sink should be large enough to permit adequate disbursement of heat across window 2 and small enough or otherwise shaped so that heat sink 20 does not unduly hinder visibility through window 2.

The heating element 22 attached to the heat sink 20 may be a coil heating element made from resistant wire, a ribbon made essentially by flattening such wire, or a heating strip cut from a broader piece of resistant material. Use of such a ribbon or strip offers the advantage of producing heat faster and with less energy because of the higher surface to volume ratio as compared to a wire coil, and the increased surface contact between heating element 22 and heat sink 20. Alternatively, the heating element 22 may be a polyimide heating element, such as one constructed of an etched foil element encapsulated between two layers of polyimide film. A fluorinated ethylene propylene (FEP) adhesive may be used to attach the polyimide heater to the heat sink 20.

The heater assembly generally including heat sink 20 and heating element 22 may also be coupled to a window 2 to be kept clear of fog and frost using magnets of the type described above. As shown in FIG. 4, magnets 24 and 26 are imbedded or press-fit into opposite ends of heat sink 20. The heater assembly is then placed in face-to-face registration with one side of window 2. Magnets 16 and 18 are positioned in face-to-face registration with the opposite side of window 2. When opposite poles of magnets 26 and 16 and of magnets 26 and 18 face each other as shown in FIG. 4, these magnets serve to hold the defroster 1 in place. When the power source 3 is connected to, and thereby energizes, heating element 22, heat generated by heating element 22 is transferred to heat sink 20 and then from heat sink 20 to window 2, causing the window to warm preventing the formation of frost or fog, and eliminating any frost or fog that accumulated prior to the heating element 22 being energized.

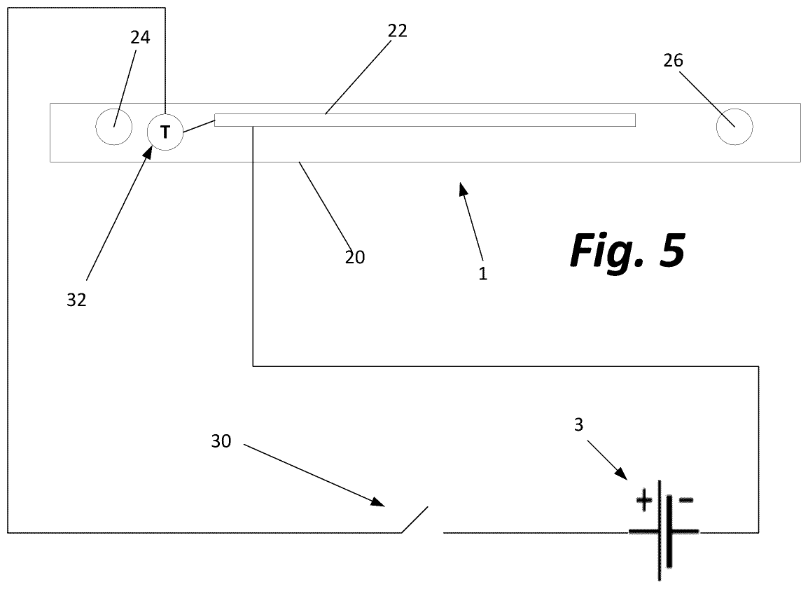

Additional features may be included in other embodiments of the invention. As indicated in FIG. 5, these additional features may include a power switch 30 and a thermostat 32 added to the embodiment of FIGS. 2 and 4. Switch 30 may be used to turn on and off the flow of current from the power source. Thermostat 32 includes a bimetallic strip converting a temperature change (of the heat sink) into mechanical displacement. Specifically, the bimetallic strip serves as a switch, closing the circuit when the heat sink 20 is at (or below) the lowest temperature of a predetermined operating temperature range and opening the circuit whenever the highest temperature of a predetermined operating temperature is reached. The thermostat may also include a mechanism allowing a user to set a desired temperature for the heat sink. The same switch and thermostat may also be used in conjunction with the embodiment of FIGS. 1 and 3.

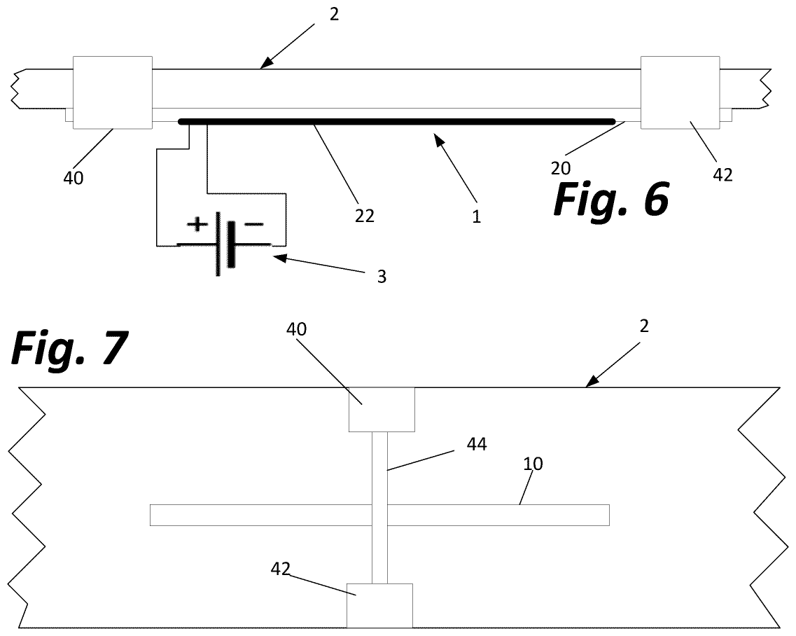

Fasteners other than the magnets described above may be used to temporarily couple the heater to the window 2 in a manner that allows for easy repositioning. As shown in FIG. 6, the heater comprising heat sink 20 and heat strip 22 is attached along an edge of the window 2 using a pair of spring clips or spring binders (collectively referred to as “spring binder clips”) 40 and 42. The heat sink 20 is placed in face-to-face registration with a surface of the window. One side of each of the spring binder clips 40 and 42 engages the heat sink 20 while the other side of the spring binder clips 40 and 42 engages the opposite surface of the window. A pinching force is applied by these sides of the spring binder clips 40 and 42 which serves to hold the heater in place. Application of sufficient force to overcome this pinching force releases the heater permitting the heater to be removed or repositioned.

As shown in FIG. 7, the heater comprising metal bar 10 is attached to the window 2 away from each edge of the window 2 using a pair of spring binder clips 40 and 42, in combination with a strap 44. Metal bar 10 is placed in face-to-face registration with a first surface of the window. Strap 44 is extended over the metal bar 10 and substantially across the length of window 2 from edge to edge such that the metal bar is sandwiched between the strap and the first surface of window 2. One side of each of the spring binder clips 40 and 42 engages an end of the strap while the other side of each of the spring binder clips 40 and 42 engages the opposite surface of the window. A pinching force is applied by the spring binder clips 40 and 42 to the opposite ends of strap 44 which serves to hold the strap and heater in place. Application of sufficient force to overcome this pinching force releases the strap and heater permitting the heater to be removed or repositioned.

One skilled in the art will appreciate that the heater can be attached to the surface of the window in other ways such as by using hook and loop type fasteners. Adhesives may also be used. For example, an adhesive strip may be applied to a surface of either the metal bar 10 or heat sink 20 and the adhesive strip may then be brought into contact with window 2 causing the heater to stick to the window. The adhesive may be used to permanently affix the heater to the window. However, such an adhesive fastener should permit the heater to be easily detached from the window and then reattached using the same adhesive strip after the heater is repositioned.

The ability to reposition the heater offers an important advantage related to power consumption, particularly when the power source is a battery. Power consumption may be reduced by defrosting only a selected portion of the window. Lithium-ion batteries offer the advantages of being rechargeable and portable. A twelve-volt, twelve amp-hour battery typically weighs under five pounds and can power a heater drawing four amps for at least three hours. This is often a sufficient length of time, but if a hunter, for example, plans on being in the blind for a longer time, a larger capacity battery or multiple batteries may be used to power the heater and thereby defog or defrost a portion of the window.

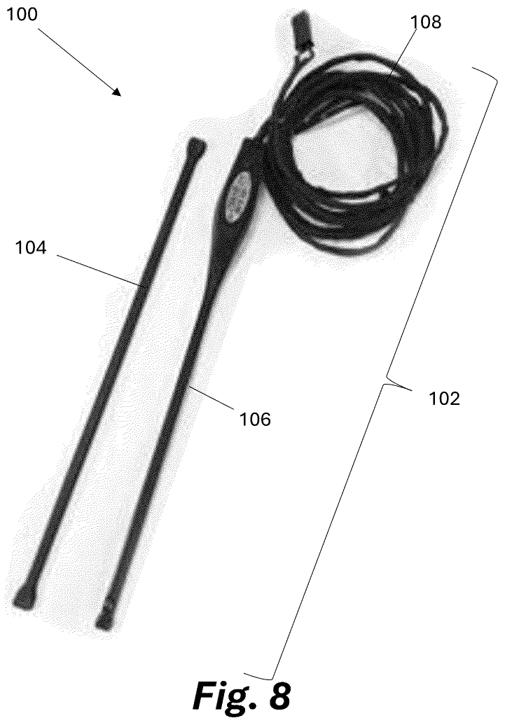

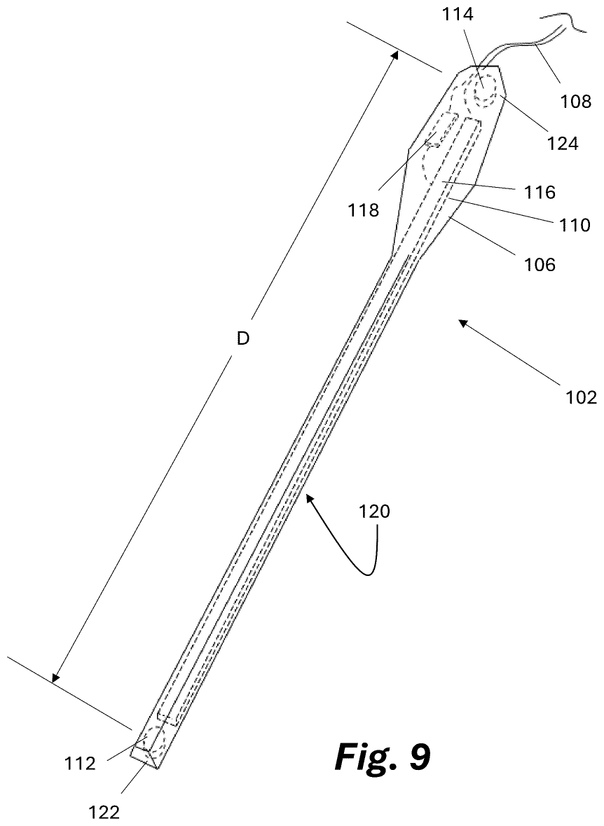

Other embodiments of a window defroster system 100 are depicted in FIGS. 8-16. As depicted in FIG. 8, window defroster system 100 in basic form generally includes heater assembly 102, and backer bar assembly 104. Heater assembly 102 generally includes heater 106 and power cable 108. Heater 106 generally includes housing 110, magnets 112, 114, heater bar 116, and optional thermostat 118. Housing 110 can be made from any suitable plastic or other material, and window-facing side 120 defines recesses (not depicted) for receiving magnets 112, 114, heater bar 116, and if provided, thermostat 118. Magnet 112 is disposed proximate distal end 122 of housing 110, and magnet 114 is disposed proximate proximal end 124 of housing 110 as depicted in FIG. 9. Magnets 112, 114, are spaced-apart by distance D, and can be made from ferrite, cobalt, neodymium, or any other material suitable for the temperature range and magnetic strength required. Heater bar 116 can be either of the metal bar 10, or heat sink 20 and heating element 22, configurations as previously described.

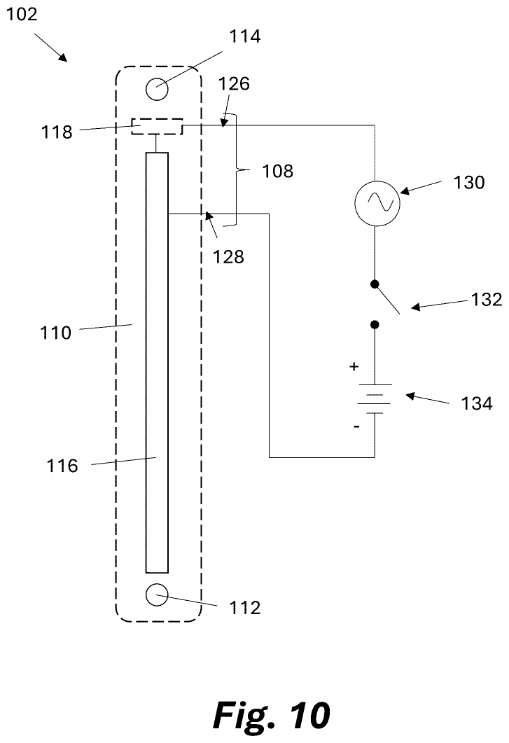

FIG. 10 is a schematic diagram of the electrical connections of heater assembly 102. As depicted, heater bar 116 is contained in housing 110, along with magnets 112, 114, and thermostat 118. Positive lead 126 and negative lead 128 are included in power cable 108. Fuse 130 having a suitable amperage rating can be provided to protect the circuit against damage from excessive current draw, and switch 132 provides the ability to turn the heater on and off. Again, power source 134 can be a battery, such as a commonly available rechargeable lithium-ion battery, or a generator.

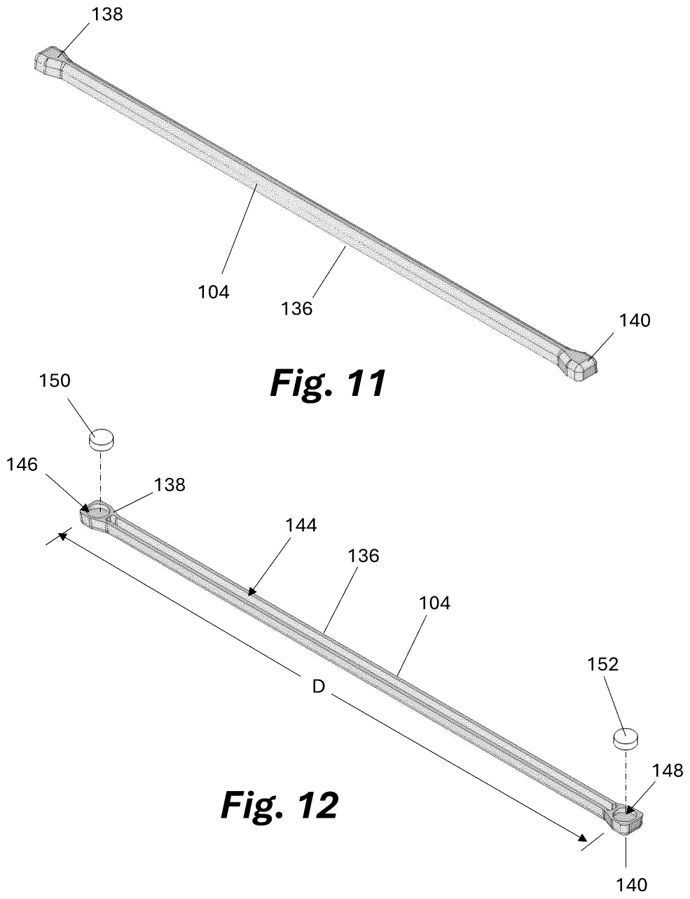

FIGS. 11 and 12 depict backer bar assembly 104. Backer bar assembly 104 generally includes body 136 presenting distal end 138 and proximal end 140. Body 136 can be made from plastic, or any other suitable material. As depicted in FIG. 12, window-facing side 142 defines longitudinal recess 144, and recesses 146, 148, which receive magnets 150, 152, respectively. Recesses 146, 148, and magnets 150, 152, are spaced-apart by distance D, which matches the distance D spacing of magnets 112, 114. Again, magnets 150, 152, can be made from ferrite, cobalt, neodymium, or any other material suitable for the temperature range and magnetic strength required. It will be appreciated that backer bar assembly 104 provides a convenient way of locating magnets 150, 152, so that they will not be easily lost as might happen with loose magnets. Also, magnets 150, 152, are automatically spaced-apart by the correct distance D to match magnets 112, 114, to ease installation of window defroster system 100 on a window.

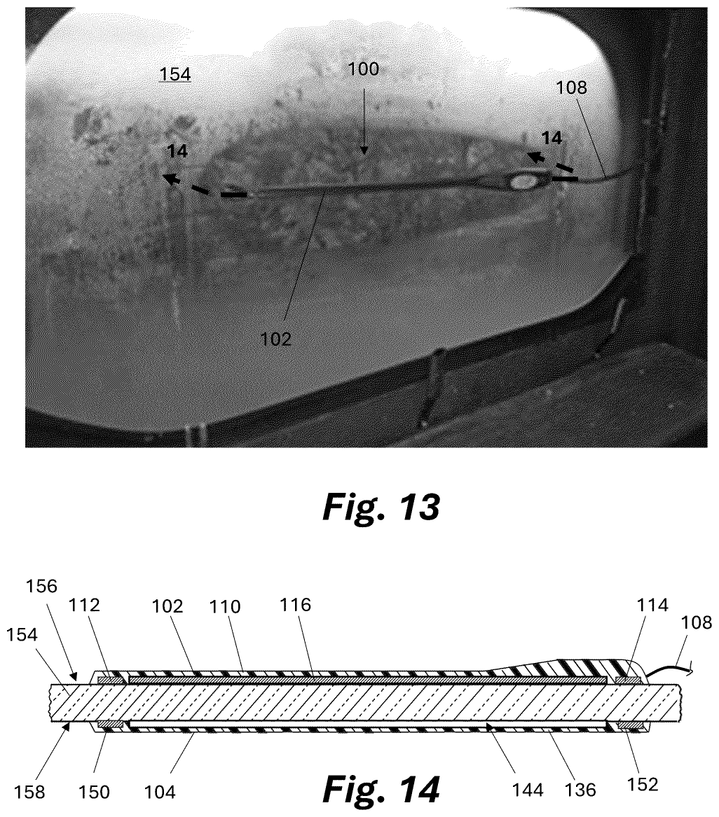

FIGS. 13 and 14 depict window defroster system 100 installed on a window 154. Heater assembly 102 is placed on inner surface 156 of window 154 and backer bar assembly 104 is placed on outer surface 158 of window 154 with magnets 112, 114, and 150, 152, respectively registered with each other. The mutual attraction between magnets 112 and 150 and 114 and 152 retains heater assembly 102 in place in the desired position. An additional advantage of window defroster system 100 in hunting blind applications such as that depicted is that the scent created by wiping condensation or frost from windows using cleaners is avoided.

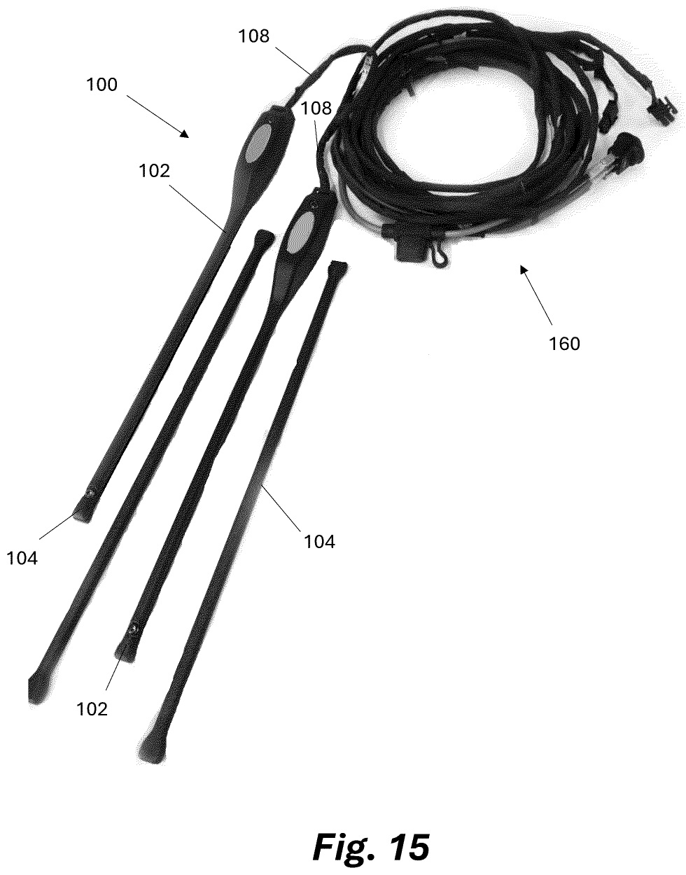

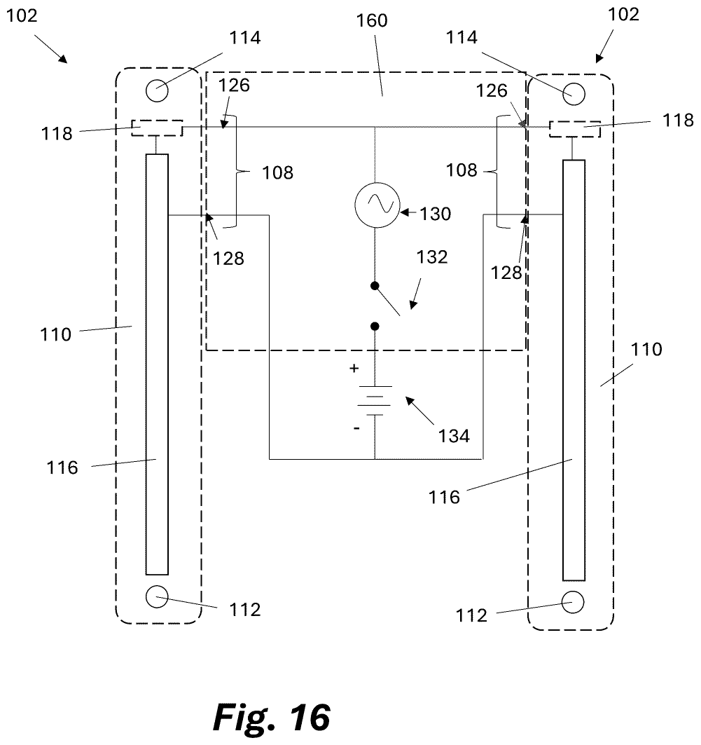

FIG. 15 depict an embodiment in which window defroster system 100 has two heater assemblies 102 and corresponding backer bar assemblies 104 to enable use on multiple windows. In such embodiments, wiring harness 160 enables connection to power supply 134. Wiring harness 160 generally includes fuse 130, switch 132, and power cables 108, which each have quick connector 162 for easy connection to power supply 134. It will be appreciated that, although two heater assemblies 102 are depicted, additional heater assemblies 102 could be provided and connected, only limited by the capacity of power supply 134.

Various additional advantages of the present inventions should be apparent to one of ordinary skill in the art from the foregoing detailed description and the accompanying drawings. This disclosure is therefore not intended to be limiting.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A window defroster system comprising:
a heater assembly configured to operate within an operating temperature range of 80 degrees Fahrenheit to 110 degrees Fahrenheit, and be placed in face-to-face registration with a first side of a window, the heater assembly having an elongate housing with a first pair of magnets, the first pair of magnets being spaced-apart by a first distance;
a backer bar assembly configured to be placed in face-to-face registration with a second, opposing, side of the window, the backer bar assembly having an elongate housing with a second pair of magnets, the second pair of magnets being spaced-apart such that each magnet of the second pair is registerable with a separate one of the magnets of the first pair of magnets; and
a portable power source electrically coupled to deliver power to the heater assembly.

2. The window defroster system of claim 1, wherein the heater assembly further comprises a thermostat operably coupled to maintain a temperature within the operating temperature range.

3. The window defroster system of claim 1, wherein the heater assembly further comprises a switch electrically coupled to connect and disconnect a flow of power between the portable power source and the heater assembly.

4. The window defroster system of claim 1, further comprising a second heater assembly and a second backer bar assembly.

5. The window defroster system of claim 1, wherein the heater assembly includes a heater bar.

6. The window defroster system of claim 5, wherein the heater bar comprises a heating element and a heat sink.

7. The window defroster system of claim 6 wherein the heating element is a polyimide heater having an etched foil encapsulated between two layers of polyimide film.

8. The window defroster of claim 6 wherein the heating element is made from a material that is resistive, has a melting point above the highest temperature of the predetermined operating temperature range, and has a temperature coefficient of resistivity sufficiently low to enable the heater to generate sufficient heat to defrost and defog the window.

9. The window defroster system of claim 8 wherein said material is selected from a group consisting of aluminum, black anodized aluminum, nickel-chromium alloy, iron-chromium-aluminum alloy, and copper-nickel alloy.

10. The window defroster system of claim 1, wherein the first pair of magnets and the second pair of magnets are made from a material selected from the group consisting of ferrite, cobalt, and neodymium.

11. A window defroster system comprising:
a pair of heater assemblies, one of the pair of heater assemblies adapted to be placed in face-to-face registration with a first side of a first window, the other one of the pair of heater assemblies adapted to be placed in face-to-face registration with a first side of a second window, each heater assembly having an elongate housing presenting a proximate end, a distal end, and having a pair of magnets disposed in the elongate housing, one of the pair of magnets being disposed proximate the proximal end, and the other one of the pair of magnets being disposed proximate the distal end;
a pair of backer bar assemblies, each one of the pair of backer bar assemblies presenting a proximate end, a distal end, and having a pair of backer bar magnets disposed in the elongate housing, one of the pair of backer bar magnets being disposed proximate the proximal end, and the other one of the pair of backer bar magnets being disposed proximate the distal end, a spacing distance between the backer bar magnets of each backer bar assembly being selected to match a spacing distance between the pair of magnets of a corresponding one of the pair of heater assemblies;
a portable power source; and
a wiring harness electrically coupling the portable power source with the pair of heater assemblies.

12. The window defroster system of claim 11, wherein the portable power source is a rechargeable lithium-ion battery.

13. The window defroster system of claim 11, wherein each heater assembly further comprises a thermostat.

14. The window defroster system of claim 11, wherein the wiring harness includes a switch electrically coupled to connect and disconnect a flow of power between the portable power source and the heater assemblies.

15. The window defroster system of claim 11, wherein each heater assembly includes a heater bar.

16. The window defroster system of claim 15, wherein the heater bar comprises a heating element and a heat sink.

17. The window defroster system of claim 16, wherein the heating element is a polyimide heater having an etched foil encapsulated between two layers of polyimide film.

18. The window defroster of claim 16 wherein the heating element is made from a material that is resistive, has a melting point above the highest temperature of a predetermined operating temperature range, and has a temperature coefficient of resistivity sufficiently low to enable the heater to generate sufficient heat to defrost and defog the window.
